(19) United States
(12) Patent Application Publication
(10) Pub. No.: US 2016/0171419 A1
(43) Pub. Date: Jun. 16, 2016

(54) ASSISTANCE SERVICE FACILITATION

(71) Applicants: Degang ZHANG, Xi'an, Shaanxi (CN); Dehai ZHANG, Kunming, Yunnan (CN); Jun FANG, Xi'an, Shaanxi (CN); EMPIRE TECHNOLOGY DEVELOPMENT LLC, Wilmington, DE (US)

(72) Inventors: Degang ZHANG, Xi'an (CN); Dehai ZHANG, Kunming (CN); Jun FANG, Xi'an (CN)

(21) Appl. No.: 14/787,135

(22) PCT Filed: May 19, 2014
(86) PCT No.: PCT/CN2014/077783

§ 371 Date: Oct. 26, 2015

(51) Int. Cl. G06Q 10/06; G06Q 30/02; G06Q 30/00

(52) U.S. Cl. CPC G06Q 10/063112; G06Q 30/016; G06Q 30/0282

(57) ABSTRACT

In at least some examples, when an assistance requestor requests assistance for a computing task, a service provider may select one or more experts to provide the requested assistance for at least a portion of the computing task, and facilitates the requested assistance between the one or more selected experts and the requestor.

### TECHNICAL FIELD

The technologies described herein pertain generally to assistance services for software applications.

### BACKGROUND

Unless otherwise indicated herein, the approaches described in this section are not prior art to the claims in this application and are not admitted to be prior art by inclusion in this section.

Occasionally, a user of a software application may encounter problems that are beyond the user's expertise. Currently, a user typically relies upon assistance that is subscription-based or warrantee-based.

### SUMMARY

Technologies are generally described for assistance services for a software application. The various techniques described herein may be implemented in various methods, computer-readable mediums, computer programmable products, and/or systems.

In some examples, various embodiments may be implemented as methods. Some methods may include receiving, from a requestor, a request for assistance regarding a computing task; selecting one or more experts to provide the requested assistance for at least a portion of the computing task; and facilitating the requested assistance between the one or more selected experts and the requestor.

In some examples, various embodiments may be implemented as computer-readable mediums having executable instructions stored thereon. Some computer-readable mediums may store instructions that, when executed, cause one or more processors to perform operations comprising receiving information regarding one or more candidate experts; generating a request for assistance regarding a computing task; selecting one or more experts from the one or more candidate experts based on the request for at least a portion of the computing task; transmitting the request to the selected one or more experts; and receiving the requested assistance from the selected one or more experts.

In some examples, various embodiments may be implemented as systems. Some systems may include a requestor that generates a request for assistance regarding a computing task; and a service provider configured to receive the request from the requestor, select one or more experts to provide the requested assistance for at least a portion of the computing task, and facilitate the requested assistance between the one or more selected experts and the requestor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items. In the drawings:

FIG. 1 shows an example system in which assistance services may be facilitated;

FIG. 2 shows an example request feature vector and an example expert feature vector by which assistance services may be facilitated;

FIG. 3 shows an example cloud-based service provider that may facilitate assistance services;

FIG. 4 shows an example configuration of a processing flow of operations by which a cloud-based service provider may facilitate assistance services;

FIG. 5 shows another example configuration of a processing flow of operations by which a device may facilitate assistance services; and

FIG. 6 shows a block diagram illustrating an example computing device that is arranged for assistance service facilitation,

all arranged in accordance with at least some embodiments described herein.

### DETAILED DESCRIPTION

In the following detailed description, references are made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

As referenced herein, a cloud-based service may refer to a service configured to execute on one or more computers connected through a communication network such as the Internet based on distributed computing. The cloud-based service may be utilized or accessed by a user via one or more applications configured to execute on a device owned and/or operation by the user, e.g., requestor device. As an example of a cloud-based service, a web portal or a user interface may be provided on the requestor device so that the user may request the cloud-based service.

A user of a software application on a client device may have questions regarding the software application, may request technical assistance regarding the software application, and/or may request assistance in performing a task associated with the software application. As referenced herein, a request for assistance may include such questions and requests.

In some examples, a communication connection suitable for transmission of the request for assistance may be established between the client device on which the software application is hosted and a cloud-based service that may provide the requested assistance.

The user may submit the request for assistance the cloud-based service or to a service provider (e.g., a server) that hosts the cloud-based service. By way of example, but not as a limitation, when a user of Adobe Photoshop® is having trouble adjusting the brightness of a photo, the user may create a request for assistance (e.g., how to adjust the brightness of a photo) that is to be transmitted to a cloud-based customer service desk provided by Adobe®. Non-limiting examples of features listed or specified in the request for assistance may include contextual information for the software application, such as a description of a computing device, a type or version of the operating system, an internet provider, etc., used when the user encountered at least one problem with the software application. Based on the features included in the request for assistance, the cloud-based service may select a most closely matched one of the experts to provide assistance to the user.

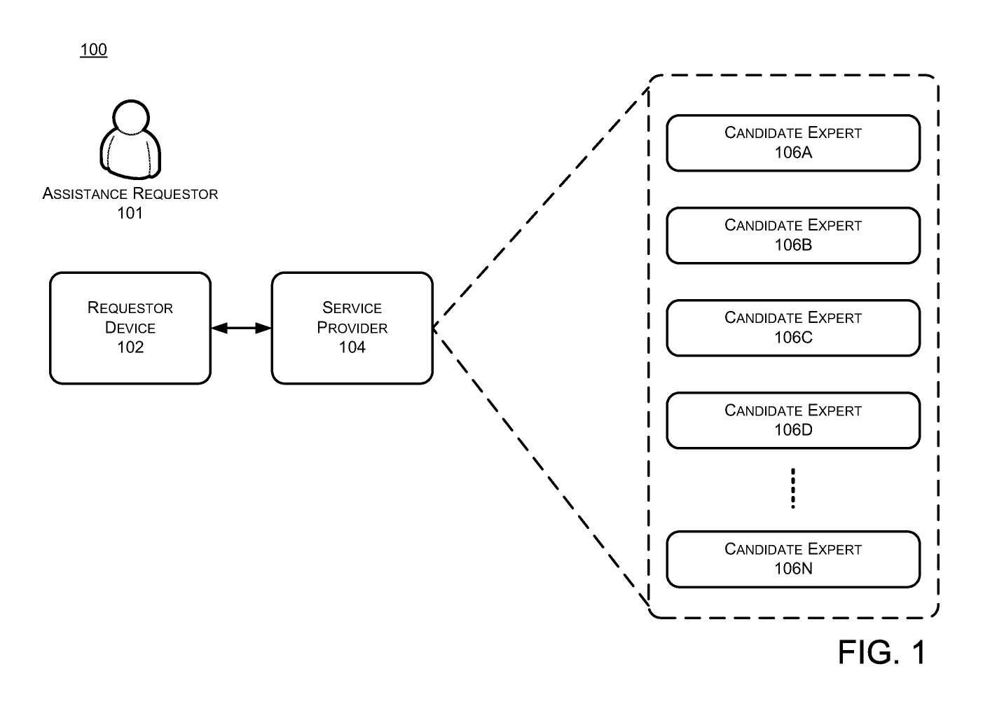

FIG. 1 shows an example system 100 in which assistance services may be facilitated, arranged in accordance with at least some embodiments described herein. As depicted, system 100 may include, at least, a requestor device 102, a service provider 104, and one or more candidate experts 106A, 106B, 106C, 106D, . . . , 106N. Candidate experts 106A, 106B, 106C, 106D, . . . , 106N are illustrated in FIG. 1 for simplicity, and one skilled in the art will appreciate that there are no limitations to the number of candidate experts that may be included in system 100. Unless context requires specific reference to one or more of candidate experts 106A, 106B, 106C, 106D, . . . , 106N, collective reference may be made to “candidate experts 106” or singular reference may be made to a representative “candidate expert 106” below. An assistance requestor 101 may communicate with service provider 104 utilizing requestor device 102.

Assistance requestor 101 may refer to a person who may submit a request for assistance regarding a software application to cloud-based service provider 104. Assistance requestor 101 may submit the request for assistance using a client device on which the software application is hosted, e.g., configured to run. Alternatively, assistance requestor 101 may submit the request for assistance from another client device different from that on which the software application is configured to run.

A non-limiting example of an example scenario in which a user of a software application submits a request for assistance is described as follows. Assistance requestor 101 may have a question regarding the use of a given software program, e.g., Adobe Photoshop®. Assistance requestor 101 may then prepare and submit the request for assistance to service provider 104, utilizing requestor device 102. The cloud based service may provide a listing of items for assistance requestor 101 to select in composing the request for assistance. The listing of items may include, for example, CPU requirements for running Adobe Photoshop® on the client device, memory requirements for running Adobe Photoshop® on the client device, etc.

Requestor device 102 may refer to a general purpose computing device that may be used by assistance requestor 101 to request assistance. Non-limiting examples of the general purpose computing device may include personal computers, tablet computers, smartphones, laptop computers, hybrid computing devices etc. Requestor device 102 may or may not be the client device on which the software application is configured to run.

As stated above, requestor device 102 is used to submit the request for assistance. The request for assistance may be represented as a request feature vector. Elements of the request feature vector may include the aforementioned items that may be relevant to running the software application, as specified by the requestor when preparing the request for assistance. As referenced herein, a feature vector may refer to a vector that includes one or more elements.

The request feature vector may be represented by a one dimensional array that has one or more elements. Each of the elements of the request feature vector may respectively pertain to an aspect of the request for assistance. The aspects may include a feature of the software application, a computing environment of the software application, and/or an expectation of the requested assistance. As non-limiting examples of these aspects, the feature of the software application may identify the main function of the software application; the computing environment of the software application may state the CPU speed requirements for the software program, memory requirements for the software program, etc; and the expectation of the requested assistance may refer to the user's expectation of the photos after editing, e.g., expected brightness.

When the request feature vector is represented by the one dimensional array, the array may be formulated as, for example, F={f₁, f₂, f₃, f₄, . . . f_{N}}, in which f₁ may represent identification of the software program, e.g., Photoshop®; f₂ may represent CPU requirements for the software program, e.g., 2 GHz or more; f₃ may represent memory requirements for the software program, e.g., 4 GB or more; f₄ may represent a user's expected brightness of the photos upon completion of a photo editing task, etc. The foregoing vector elements are examples only, and are not intended to be limiting of elements of a request feature vector. Further, one or more of the elements of the request feature vector may represent an identification of subject matter of the requested assistance, e.g., the photos to be edited. The formulated request feature vector, may be transmitted from requestor device 102 to service provider 104.

Service provider 104 may refer to one or more servers that host the cloud based service. Service provider 104 may be communicatively coupled to requestor device 102 via a network connection. Via the network connection, service provider 104 may be configured to receive the request for assistance, from requestor device 102, in the form of a request feature vector. Alternatively, or in addition, the cloud based service, hosted on service provider 104, may be configured to formulate a request for assistance into a request feature vector. For example, when the user states the request for assistance in natural language, the cloud based service may utilize some key word identifying algorithms and extract the elements from the description of the request to formulate a request feature vector. Regardless of where the request feature vector is formulated, the cloud service may be further configured to select one or more from candidate experts 106 to provide help for assistance requestor 101. To select one or more of candidate experts 106, the cloud service may be further configured to compare a received request feature vector to expert feature vectors that are respectively formulated to list the qualifications for candidate experts that are assigned, registered, or otherwise associated with service provider 104. An expert feature vector may also refer to a one dimensional array that includes one or more elements. Each of the elements may respectively represent a feature or facet of a software program for which a respective one of candidate experts 106 may claim to have expertise. The process of selecting an expert is described in greater detail below.

Candidate experts 106 may refer to one or more experts with an area of expertise pertaining to various software applications. Candidate experts 106 may be associated with service provider 104. Thus, information regarding candidate experts 106, e.g., identities, expertise, ratings, reviews, etc., may be accessible to the cloud based service. Based on the information regarding candidate experts 106, an expert feature vector may be generated and assigned, by the cloud based service, to each of candidate experts 106.

As described above, the expert feature vector may include one or more elements. Each of the elements respectively represents a feature or facet of a software program for which a respective one of candidate experts 106 may claim to have expertise. Each expert feature vector may be formulated into a one dimensional array such as Fₜ={fₜ₁, fₜ₂, fₜ₃, . . . }, in which fₜ₁ may represent an area of expertise of the candidate expert, e.g., skilled in Photoshop®; fₜ₂ may represent a computing capability of a computer by which the candidate expert may provide assistance, e.g., the CPU speed of the candidate expert's computer; fₜ₃ may represent another computing capability of a computer by which the candidate expert may provide assistance, e.g., the available memory of the candidate expert's computer; etc.

Further to the elements listed above, the elements of the expert feature vector may also include a proficiency level of a candidate expert 106. The proficiency level of a candidate expert 106 may refer to a value that represents a level of proficiency with the software program for which the candidate expert 106 claims to have expertise. In some example embodiments of an expert feature vector, the proficiency level may include an objective metric that is deemed to be indicative of a level of skill for the respective candidate expert 106. As non-limiting examples, the proficiency level may indicate an average time in which the respective candidate expert 106 finishes assigned tasks for the respective aspect of the software program; or the proficiency level may indicate a level at which the respective candidate expert 106 operates input devices while using the required software, e.g., a mouse click rate and a keyboard input rate.

As referenced herein, the mouse click rate may refer to a count of clicking that the candidate expert clicks a mouse within a given time period, e.g., 30 counts/minute. The keyboard input rate may refer to a count of pressing that the candidate expert presses keys on the keyboard within a given time period, e.g., 25 counts/minute. Such count may be collected by currently existing software programs, e.g., APM counter, installed on the computing device on which the candidate expert operates. Based on the mouse click rate and the keyboard input rate, the proficiency level may be calculated in accordance with the following formula:

$${P}_{s} = {W}_{m} \frac{{M}_{m}}{t} + {W}_{k} \frac{{M}_{k}}{t}$$

in which Pₛ represents the proficiency level, t represent the given time period, Mₘ represents the count of clicking that the candidate expert clicks a mouse within the given time period, Mₖ represents the count of pressing that the candidate expert presses keys on the keyboard within a given time period, and Wₘ and Wₖ respectively represents a weight adjustable by the system administrator.

The elements of the expert feature vector may also include a customer rating level of a candidate expert 106. The customer rating level may be a value generated based on customer reviews for the respective candidate expert 106. In some example embodiments of an expert feature vector, the customer rating level may include a subjective metric that is deemed to be indicative of a level of skill for the respective candidate expert 106. As non-limiting examples, the customer rating levels may be a rating value, e.g., a number of stars. In at least some examples, a customer rating level may be calculated in accordance with the algorithms that may be utilized to extract people's opinions from the customer reviews posted on review websites, e.g., the algorithms described in articles including “Mining Opinion Features in Customer Reviews,” M. Hu and B. Liu, In Proceedings of Nineteenth National Conference on Artificial Intelligence (2004) and “Mining the Peanut Gallery: Opinion Extraction and Semantic Classification of Product Reviews,” Dave K. Lawrence and Pennock D. (2003).

The foregoing vector elements are examples only, and are not intended to be limiting of elements of an expert feature vector. That is, respective feature vectors may include different combinations of elements in varying order.

The cloud based service, hosted on service provider 104, may be configured to calculate a similarity value between the request and each of candidate experts 106 by comparing the request feature vector to each of the expert feature vectors. As an non-limiting example, the similarity value may be calculated using the following formula:

sim(F,Fₜ)=1−∥αF−βFₜ∥

in which sim( ) represents the similarity value, α and β respectively represent a value adjustable by a system administrator, and ∥ ∥ represents a distance between the request feature vector and the respective candidate feature vectors. In some situations, α and β may be adjusted by the system administrator so that the calculation of the similarity may yield more accurate results. The distance between the request feature vector and the respective candidate feature vectors may be calculated in accordance with currently defined mathematical concepts, e.g., Euclidean distance, Chebyshev distance, Hamming distance, Mahalanobis distance, Manhattan distance, Minkowski distance, etc. Service provider 104 may be configured to select a subset of candidate experts 106 by comparing the calculated similarity value to a threshold value that may be predetermined by the system administrator. That is, if a similarity value between the request and one of candidate experts is greater than the threshold value, the corresponding candidate expert may be selected as one of the subset of candidate experts 106. For example, assuming the calculated similarity values for candidate experts 106 are 1, 1, 4, 3, 2, 1, and the predetermined threshold value is 2.5, the candidate experts corresponding to the similarity values of 3 and 4 may be selected as the subset of candidate experts 106.

Service provider 104 may be configured to facilitate the requested assistance between the one or more selected experts and assistance requestor 101. In at least some examples, service provider 104 (or requestor device 102) may be configured to transmit the subject matter of the requested assistance, e.g., the photos, together with the request to computing devices on which the one or more selected experts operate. The selected experts may use their expertise to complete the task (e.g., edit the photos) and, further, to transmit, utilizing the computing devices, the solved problem (e.g., the edited photos) back to service provider 104 (or requestor device 102). In some other examples, service provider 104 may be configured to exchange contact information (e.g., IP address) between the computing devices, on which the selected experts operate, and requestor device 102 so that a direct communication link may be established between the computing devices and requestor device 102. The selected experts may then remotely control requestor device 102 to complete the task.

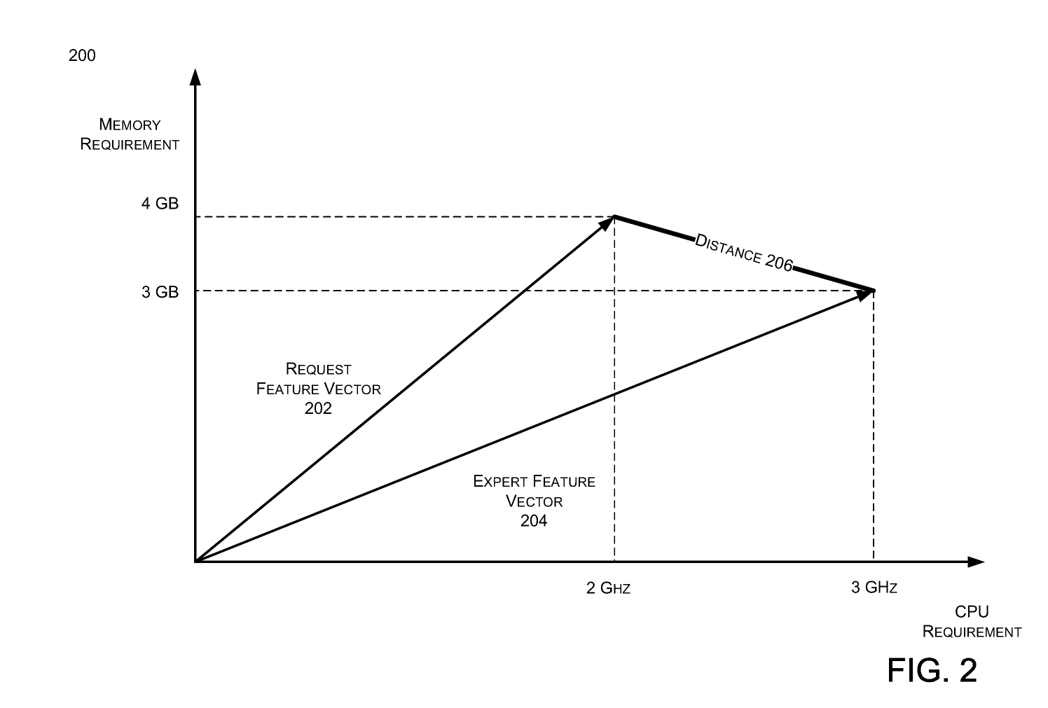

FIG. 2 shows an example request feature vector 202 and an example expert feature vector 204 by which assistance services may be facilitated. Request feature vector 202 and expert feature vector 204 are illustrated in FIG. 2 as two dimensional vectors for simplicity and one skilled in the art will appreciate that a different number of dimensions of the respective vector.

Request feature vector 202 may refer to a vector generated by requestor device 102 to indicate the system requirements for solving the problem that assistance requestor 101 encounters. As depicted, request feature vector 202 indicates that the CPU for solving the problem should be faster than 2 GHz and the memory should be larger than 4 GB.

Expert feature vector 204 may refer to a vector generated by service provider 104 to represent the system capability of a computing system utilized by the expert to solve the problem. As depicted, expert feature vector 204 indicates that the computing system utilized by the expert includes a CPU of 3 GHz and a memory of 3 GB.

Distance 206 may indicate the Euclidean distance between request feature vector 202 and expert feature vector 204. As described above, distance 206 may serve as a basis for the calculation of the similarity value and, further, for the selection of the subset of candidate experts 106.

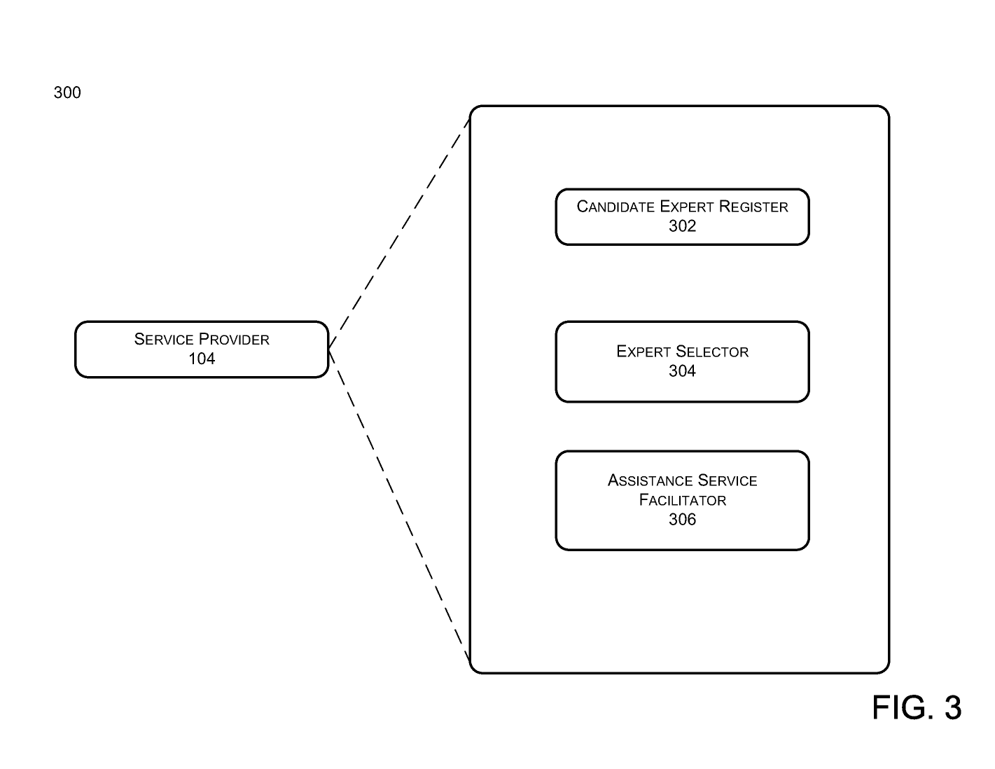

FIG. 3 shows an example cloud-based service provider 104 that may facilitate assistance services, arranged in accordance with at least some embodiments described herein. As depicted, the cloud based service, hosted on service provider 104, may include, at least, a candidate expert register 302, an expert selector 304, and an assistant service facilitator 306.

Candidate expert register 302 may refer to a component that may be configured store information pertaining to registered candidate experts 106. The stored information regarding the respective candidate experts 106 may include information that may be entered into expert feature vectors, including, e.g., identification information, expertise pertaining to the respective cloud-based service, performance ratings, proficiency levels, customer reviews, etc. In accordance with various example embodiments, candidate expert register 302 may be implemented as hardware, software, firmware, or any combination thereof.

Expert selector 304 may refer to a component that may be configured to select a subset of candidate experts 106 based on the calculated similarity value and the threshold value that may be predetermined by the system administrator. That is, based on the feature vector and the capability vector determined as described above, expert selector 304 may be configured to compare the request feature vector to the two or more expert feature vectors and calculate a similarity value between the request and each of respective candidate experts 106. If a similarity value between the request and one of candidate experts is greater than the threshold value, the corresponding candidate expert may be selected as one of the subset of candidate experts 106 to assist assistance requestor 101. In accordance with various example embodiments, expert selector 306 may be implemented as hardware, software, firmware, or any combination thereof.

Assistance service facilitator 306 may refer to a component that may be configured to facilitate the requested assistance between the one or more selected experts and the requestor. In at least some examples, assistance service facilitator 308 may be configured to transmit the subject matter of the requested assistance, e.g., the photos, together with the request for assistance to the computing devices on which the one or more selected experts operate. The selected experts may use their expertise to complete the task, e.g., edit the photos, and, further, transmit the completed task, e.g., the edited photos, back to assistance service facilitator 308. In some other examples, assistance service facilitator 308 may be configured to exchange contact information, e.g., IP address, between the computing devices on which the selected experts operate and requestor device 102 so that a direct communication link may be established between the computing devices and requestor device 102. The selected experts may then remotely control requestor device 102 to complete the task. In accordance with various example embodiments, assistance service facilitator 308 may be implemented as hardware, software, firmware, or any combination thereof.

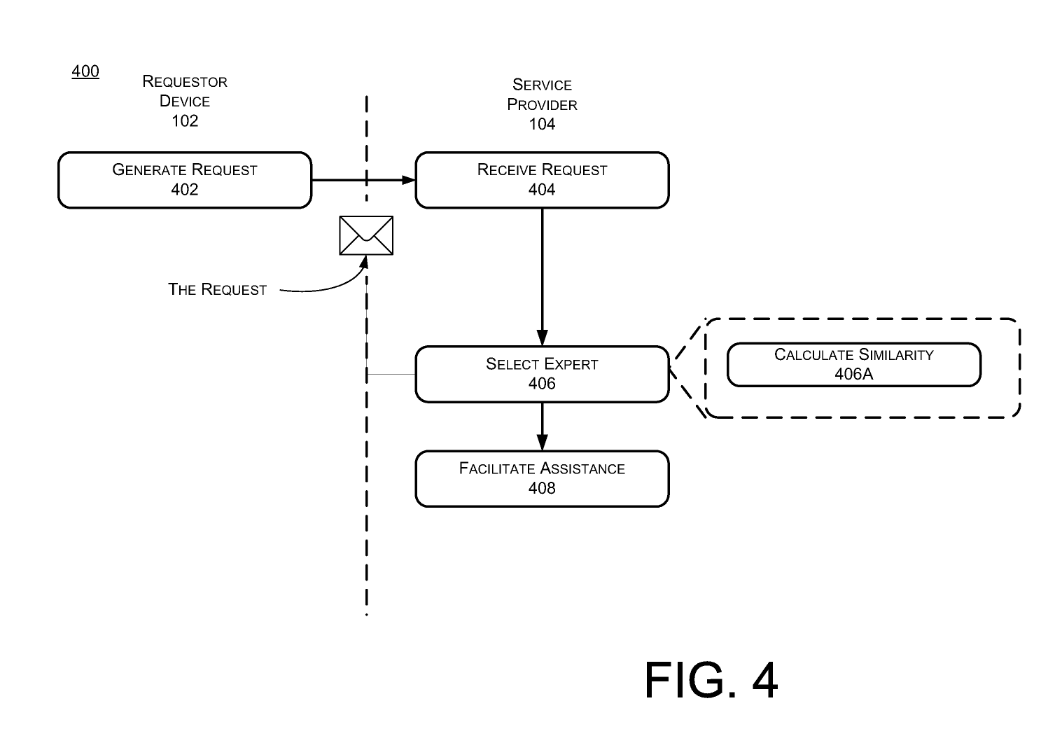

FIG. 4 shows an example configuration of a processing flow of operations by which a cloud-based service provide may facilitate assistance services, arranged in accordance with at least some embodiments described herein. As depicted, processing flow 400 may include processes executed by various components that are part of example system 100. However, processing flow 400 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 400 may include various operations, functions, or actions as illustrated by one or more of blocks 402, 404, 406, and/or 408. Block 406 may include, at least, sub-block 406A. Processing may begin at block 402.

Block 402 (Generate Request) may refer to requestor device 102 used by assistance requestor 101 to generate a request for assistance. The request for assistance may be formulated into a feature vector on requestor device 102, although alternative embodiments may contemplate the request for assistance being formulated into a feature vector on or at service provider 104. Each element of the request feature vector may respectively pertain to a feature of the software program, a computing environment of the software program, and/or an expectation of the requested assistance. In some examples, the request feature vector may be formulated as a one dimensional array, for example, F={f₁, f₂, f₃, f₄, . . . f_{N}}, in which f₁ may represent identification of the software program, e.g., Photoshop®; f₂ may represent CPU requirements for the software program, e.g., 2 GHz or more; f₃ may represent memory requirements for the software program, e.g., 4 GB or more; f₄ may represent a user's expected brightness of the photo upon completion of the photo editing task, etc. The foregoing vector elements are examples only, and are not intended to be limiting of elements of a request feature vector. Further, one of the elements of the request feature vector may represent an identification of subject matter of the requested assistance, e.g., the photos to be edited. The formulated request feature vector may be transmitted from requestor device 102 to service provider 104. In the alternative, the elements may be transmitted from request device 102 to service provider 104, on which the cloud based service may then formulate the elements into the request feature vector. Block 402 may be followed by block 404.

Block 404 (Receive Request) may refer to service provider 104 receiving the request feature vector or, in the alternative, the request for assistance, from requestor device 102 via a network connection. If the request for assistance is received, block 404 may also refer to the cloud based service formulating the request for assistance into the request feature vector on service provider 104.

The network connection may refer to one or more communication links that follow at least one of communication protocols. The communication protocols may include any mobile communications technology, e.g., Global System for Mobile Communications (GSM), Code Division Multiple Access (CDMA), etc., depending upon the technologies supported by particular wireless service providers. The one or more communication links may be implemented utilizing non-cellular technologies such as conventional analog AM or FM radio, Wi-Fi™, wireless local area network (WLAN) or IEEE 802.11, Worldwide Interoperability for Microwave Access (WiMAX™), Bluetooth™, hard-wired connections, e.g., cable, phone lines, and other analog and digital wireless voice and data transmission technologies. Block 404 may be followed by block 406.

Block 406 (Select Expert) may refer to the cloud based service, executing on service provider 104, selecting one or more of candidate experts 106 to provide the requested assistance for assistance requestor 101 based on a comparison of the request feature vector and the two or more candidate feature vectors. Block 406 may include, at least, sub-block 406A.

Sub-block 406A (Calculate Similarity) may refer to expert selector 204 calculating a similarity value between the formulated request feature vector and each of the formulated expert feature vectors for the respective candidate experts 106. The similarity value may be calculated in accordance with the following formula:

sim(F,Fₜ)=1−∥αF−βFₜ∥

in which sim( ) represents the similarity value, α and β respectively represents a value adjustable by a system administrator, and ∥ ∥ represents a distance between the request feature vector and the respective candidate feature vectors. If a similarity value between the request and one of candidate experts 106 is greater than a threshold value that may be predetermined by the system administrator, the corresponding candidate expert may be selected one of the subset of candidate experts 106. Sub-block 406A may be followed by block 408.

Block 408 (Facilitate Assistance) may refer to assistance service facilitator 206 facilitating the requested assistance between the one or more selected experts and the requestor. In at least some examples, assistance service facilitator 208 may be configured to transmit the subject matter of the requested assistance, e.g., the photos, together with the request to the computing devices utilized by the one or more selected experts. The selected experts may use their expertise to complete the task (e.g., edit the photos) and, further, to transmit, utilizing the computing devices, the completed task (e.g., the edited photo) back to assistance service facilitator 208. In some other examples, assistance service facilitator 208 may be configured to exchange contact information (e.g., IP address) between the computing devices and requestor device 102 so that a direct communication link may be established between the computing devices and requestor device 102. The selected experts may then remotely control requestor device 102 to complete the task. In either situation, each of the selected experts may complete at least a portion of the task, e.g., one of the photos to be edited.

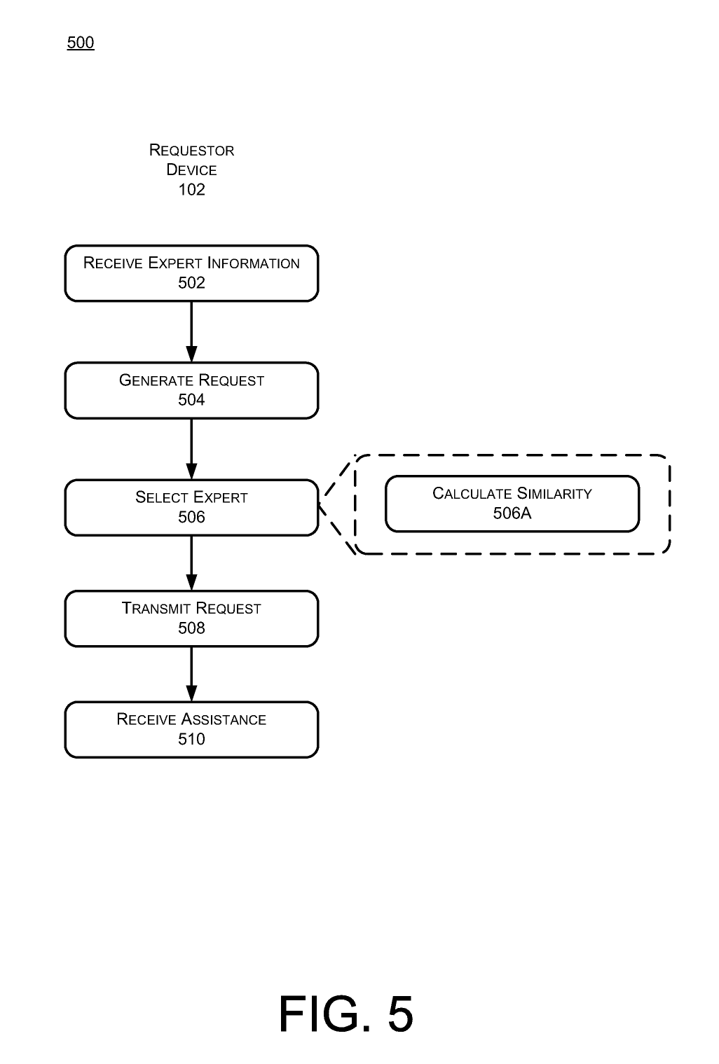

FIG. 5 shows another example configuration of a processing flow of operations by which assistance services may be facilitated, arranged in accordance with at least some embodiments described herein. As depicted, processing flow 500 may include processes executed by various components that are part of example system 100. However, processing flow 400 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 500 may include various operations, functions, or actions as illustrated by one or more of blocks 502, 504, 506, 508, and/or 510. Block 506 may include, at least, sub-block 506A. Processing may begin at block 502.

Block 502 (Receive Expert Information) may refer to requestor device 102 receiving information regarding candidate experts 106, e.g., identities, expertise, ratings, reviews, etc. Such information may be stored in a data storage associated with requestor device 102. Block 502 may be followed by block 504.

Block 504 (Generate Request) may refer to requestor device 102 being utilized by assistance requestor 101 to generate a request for assistance. The request for assistance may include the description of a task, which may be in a form of a feature vector. Each of element of the feature vector may respectively represent a requirement of the task and/or an expectation of the requested assistance. That is, the feature vector may be formulated in a form of F={f₁, f₂, f₃, f₄, . . . f_{N}}, in which f₁ represents the identification of the software program, e.g., Photoshop®, f₂ represents the required CPU, e.g., 2 GHz or better, f₃ represents the required memory, e.g., 4 GB or more, f₄ represents that an expected brightness of the photo, etc. Additionally, one of the elements may represent an indication of a subject matter of the requested assistance, e.g., the photos to be edited. The request may serve as a basis for selecting one or more experts from among candidate experts 106. Block 504 may be followed by block 506.

Block 506 (Select Expert) may refer to requestor device 102 being utilized to select one or more experts from candidate experts 106 for assistance requestor 101 based on the request. Block 506 may include, at least, sub-block 506A.

Sub-lock 506A (Calculate Similarity) may refer to requestor device 102 being utilized to calculate a similarity value between the request and each of candidate experts 106 based on the feature vector included in the request and the capability vector associated with each candidate expert. The similarity value may be calculated in accordance with the following formula:

sim(F,Fₜ)=1−∥αF−βFₜ∥

in which sim( ) represents the similarity value, α and β respectively represents a value adjustable by a system administrator, and ∥ ∥ represents a distance between two vectors. If a similarity value between the request and one of candidate experts 106 is greater than a threshold value that may be predetermined by the system administrator, the corresponding candidate expert may be selected one of the subset of candidate experts 106. Sub-block 506A may be followed by block 508.

Block 508 (Transmit Request) may refer to requestor device 102 transmitting the request to the identified one or more experts via a network connection. The network connection may refer to one or more communication links that follow at least one of communication protocols. The communication protocols may include any mobile communications technology, e.g., GSM, CDMA, etc., depending upon the technologies supported by particular wireless service providers. The one or more communication links may be implemented utilizing non-cellular technologies such as conventional analog AM or FM radio, Wi-Fi™, WLAN or IEEE 802.11, WiMAX™, Bluetooth™, hard-wired connections, e.g., cable, phone lines, and other analog and digital wireless voice and data transmission technologies. Block 508 may be followed by block 510.

Block 510 (Receive Assistance) may refer to requestor device 102 receiving the requested assistance from the identified one or more experts. In at least some examples, requestor device 102 may be configured to transmit the subject matter of the requested assistance, e.g., the photos, together with the request to the computing devices utilized by the one or more selected experts. The selected experts may use their expertise to complete the task, e.g., edit the photos, and, further, to transmit, utilizing the computing devices, the completed task, e.g., the edited photo, back to requestor device 102. In some other examples, requestor device 102 may establish a direct communication link with the computing devices. The selected experts may then remotely control requestor device 102 to complete the task.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

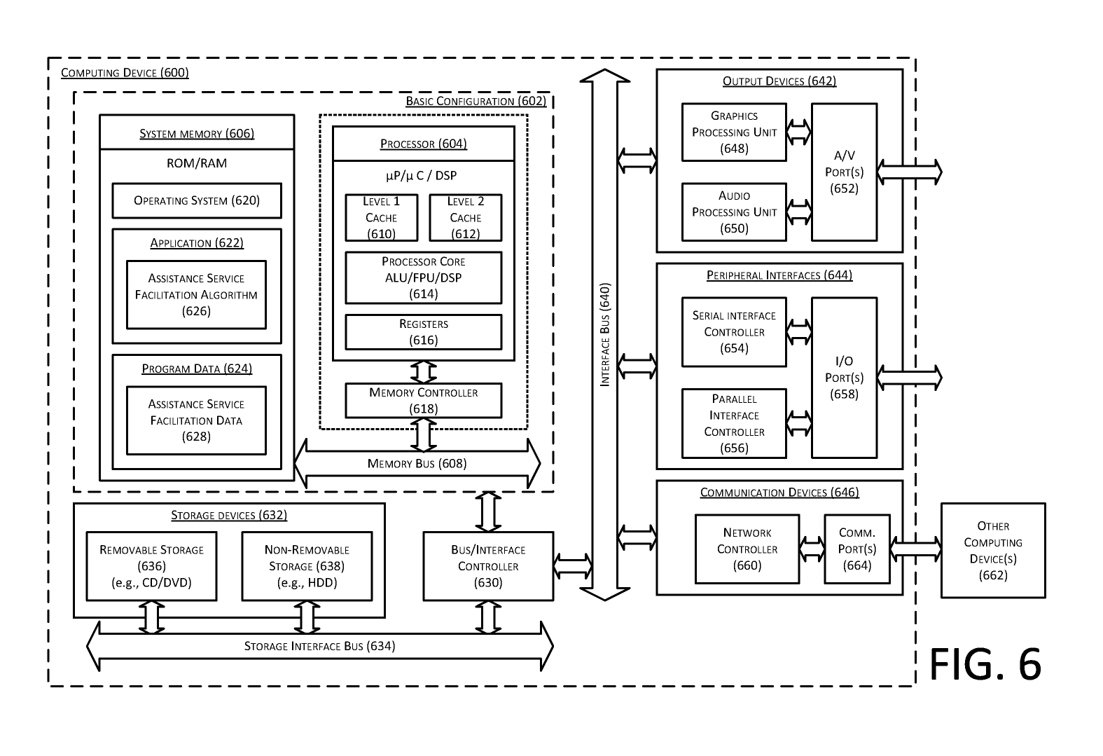

FIG. 6 shows a block diagram illustrating an example computing device that is arranged for assistance service facilitation, arranged in accordance with at least some embodiments described herein.

In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include an assistance service facilitation algorithm 626 that is arranged to perform the functions as described herein including those described with respect to process 300 of FIG. 3 and process 400 of FIG. 4. Program data 624 may include assistance service facilitation data 628 that may be useful for operation with assistance service facilitation algorithm 626 as is described herein. In some embodiments, application 622 may be arranged to operate with program data 624 on operating system 620 such that implementations of assistance service facilitation may be provided as described herein. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A service provider assistance method, comprising:
receiving, from a requestor via a communications interface, a request for assistance regarding a computing task;
selecting one or more experts to provide the requested assistance for at least a portion of the computing task, the selecting including:
calculating a similarity between the request and each of the one or more experts, based on a feature vector corresponding to the request and represented by a one-dimensional array that has one or more elements; and
facilitating the requested assistance between the one or more selected experts and the requestor.

2. The method of claim 1, wherein the request is generated as the feature vector that includes the one or more elements.

3. The method of claim 2, wherein one of the one or more elements of the feature vector represents an indication of a task that is a subject matter of the requested computing assistance.

4. The method of claim 2, wherein one of the one or more elements of the feature vector represents an expectation of the requested assistance.

5. The method of claim 1, wherein the one or more experts are selected from one or more candidate experts that are registered with a service provider.

6. The method of claim 5, wherein each of the one or more candidate experts is assigned a capability vector generated based at least on an area of expertise of a respective candidate expert.

7. The method of claim 5, wherein the calculating comprises:
calculating a similarity value between the request and each of the one or more candidate experts based on a comparison of the feature vector and one or more capability vectors of each of the respective one or more candidate experts,
wherein the feature vector is generated based on the request, and
wherein the one or more capability vectors are generated based at least on an area of expertise of each of the respective one or more candidate experts; and
choosing a subset of the one or more candidate experts based on the calculated similarity value.

8. The method of claim 7, wherein the selecting further comprises:
determining a proficiency level for each of the one or more candidate experts in the chosen subset;
determining a customer rating value for each of the one or more candidate experts in the chosen subset; and
identifying the one or more experts from the chosen subset of the one or more candidate experts based on the proficiency level and the customer rating value.

9. The method of claim 8, wherein the determining of the proficiency level is based at least on a mouse click rate and a keyboard input rate corresponding to each of the one or more candidate experts in the chosen subset.

10. The method of claim 8, wherein the determining of the customer rating value is based on one or more customer reviews.

11. A non-transitory computer-readable medium that stores executable-instructions that, when executed, cause one or more processors to perform operations comprising:
receiving information regarding one or more candidate experts;
generating a request for assistance regarding a computing task;
selecting one or more experts from the one or more candidate experts based on the request for at least a portion of the computing task, the selecting including:
calculating a similarity between the request and each of the one or more candidate experts, based on a feature vector corresponding to the request and represented by a one-dimensional array that has one or more elements;
transmitting the request to the selected one or more experts; and
receiving the requested assistance from the selected one or more experts.

12. The computer-readable medium of claim 11, wherein the operations further comprise generating the request as the feature vector that includes the one or more elements.

13. The computer-readable medium of claim 12, wherein one of the one or more elements of the feature vector represents an indication of computing assistance.

14. The computer-readable medium of claim 12, wherein one of the one or more elements of the feature vector represents an expectation of the requested assistance.

15. The computer-readable medium of claim 11, wherein the one or more candidate experts are registered with a service provider.

16. The computer-readable medium of claim 11, wherein each of the one or more candidate experts is assigned a capability vector generated based at least on an area of expertise of a respective candidate expert.

17. The computer-readable medium of claim 11, wherein the calculating comprises:
calculating a similarity value between the request and each of the one or more candidate experts based on a comparison of the feature vector and one or more capability vectors associated with each of the respective one or more candidate experts,
wherein the feature vector is generated based on the request, and
wherein the one or more capability vectors are generated based at least on an area of expertise of each of the respective one or more candidate experts; and
choosing a subset of the one or more candidate experts based on the calculated similarity value.

18. The computer-readable medium of claim 17, wherein the selecting further comprises:
determining a proficiency level for each of the one or more candidate experts in the chosen subset;
determining a customer rating value for each of the one or more candidate experts in the chosen subset; and
identifying the one or more experts from the chosen subset of the one or more candidate experts based on the proficiency level and the customer rating value.

19. A service provider assistance system, comprising:
a requestor that generates a request for assistance regarding a computing task; and
a service provider configured to:
receive the request from the requestor,
select one or more experts to provide the requested assistance for at least a portion of the computing task, including calculating a similarity between the request and each of the one or more experts, based on a feature vector corresponding to the request and represented by a one-dimensional array that has one or more elements, and
facilitate the requested assistance between the one or more selected experts and the requestor.

20. The system of claim 19, wherein the service provider is further configured to:
calculate a similarity value between the request and each of one or more candidate experts based on a comparison of the feature vector and one or more capability vectors of each of the respective one or more candidate experts,
wherein the feature vector is generated based on the request, and
wherein the one or more capability vectors are generated based at least on an area of expertise of each of the respective one or more candidate experts; and
choose a subset of the one or more candidate experts based on the calculated similarity value.

21. The system of claim 20, wherein the service provider is further configured to:
determine a proficiency level for each of the one or more candidate experts in the chosen subset;
determine a customer rating value for each of the one or more candidate experts in the chosen subset; and
identify the one or more experts from the chosen subset of the one or more candidate experts based on the proficiency level and the customer rating value.
